(19) United States
(12) Patent Application Publication
(10) Pub. No.: US 2025/0361969 A1
(43) Pub. Date: Nov. 27, 2025

(54) ANTI-CORROSION COATING FOR PROTECTION OF INNER SURFACES OF PIPES

(71) Applicant: Viacheslav Sosinskiy, Tivat (ME)

(72) Inventors: Aleksandr I. Tsybin, Lyubertsy (RU); Evgeniia S. Popova, Moscow (RU); Olga V. Shuklina, Tambov (RU)

(21) Appl. No.: 18/997,596

(22) PCT Filed: Jan. 19, 2024
(86) PCT No.: PCT/RU2024/050012

§ 371 Date: Aug. 12, 2025

(30) Foreign Application Priority Data
Feb. 14, 2023 (RU) 2023103252

(51) Int. Cl. F16L 58/10; B05D 7/22; C09D 5/08; C09D 163/00

(52) U.S. Cl. CPC F16L 58/1009; B05D 7/225; C09D 5/08; B05D 2504/00; B05D 2601/24; C09D 163/00

(57) ABSTRACT

The invention relates to the field of oil and gas production, and more particularly to the production of protective anti-corrosive coatings suitable for use in aggressive downhole oil and gas production conditions exacerbated by corrosion factors, including the deposition of salts and paraffins. The coatings are provided to protect the inner surfaces of oil tubular goods; including tanks and reservoirs for storing oil, oil-containing fluids, water and other solutions and fluids. Another goal of the invented coating is to protect pipes against corrosion during the transportation of oil, water, chemical solutions and other fluids, as well as to be used as a repair composition for the ends, outside and inside chamfers and the first two non-working turns of the threaded portion of production tubing. The invention results in improved performance characteristics and permits the production of an anti-corrosive coating that better preserves the physical, mechanical and thermomechanical properties of a material after exposure to aggressive corrosive media under pressure and at an elevated temperature.

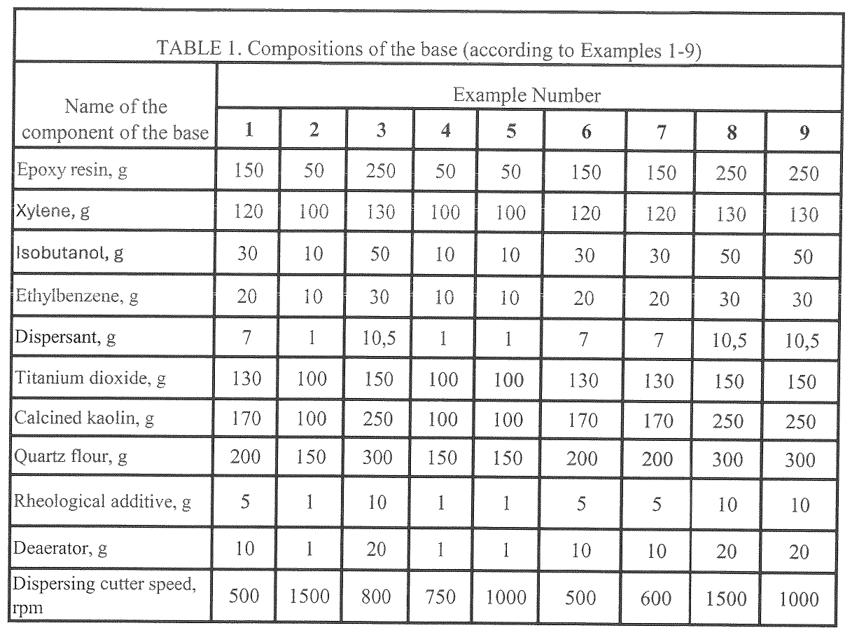

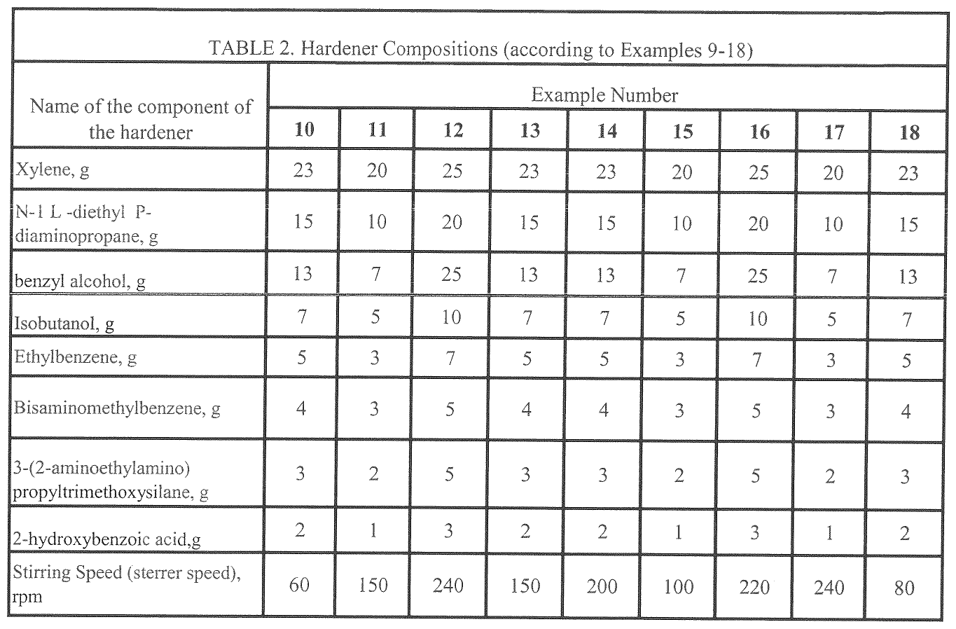

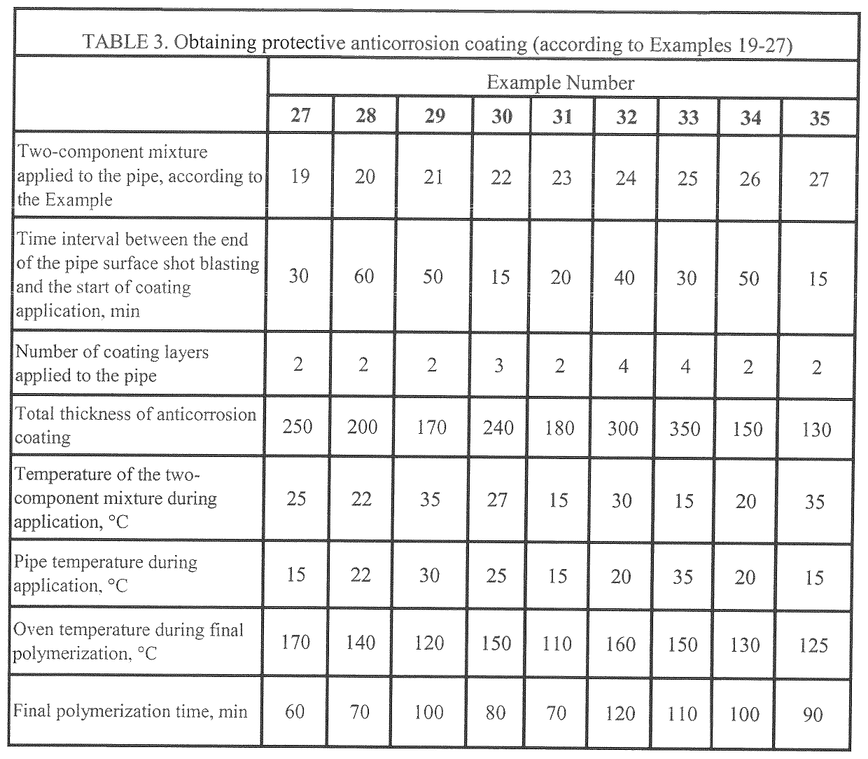

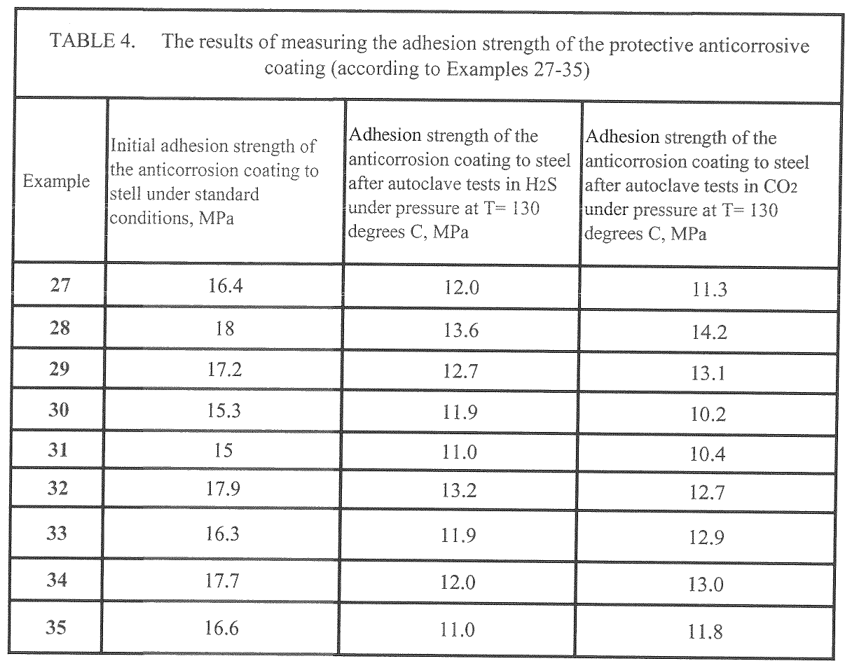

### FIELD OF THE INVENTION

The invention relates to the field of oil and gas production, in particular the invention relates to protective anti-corrosion coatings suitable for use in aggressive downhole conditions of oil and gas production complicated by corrosive factors, including salt and paraffin deposits. The invention also relates to coatings provided for protecting the inner surface of oil grade pipes; for protecting tanks and reservoirs for storing oil, oily liquids, water, other solutions and liquids; and for protecting pipelines from corrosion during transportation of oil, water, chemical solutions and liquids; as well as for protecting pipelines from corrosion during transportation of oil, water, chemical solutions and liquids. The invention also relates to coatings provided as a repair composition for the ends, outer and inner chamfers and two first non-working turns of the threaded portion of the pump compressor pipes. The invention offers enhanced technological characteristics/features, enabling the production of an anti-corrosion coating that better preserves the material's physical, mechanical, and thermomechanical properties after exposure to corrosive and aggressive environments under high pressure and elevated temperatures.

### PRIOR ART DESCRIPTION

A solidifying polymer composition and its use in protecting substrates, in particular, metal pipes are disclosed by the Russian Patent No. 2146272, published Mar. 10, 2000. The composition is a liquid at 20° C. and contains:
(1) 25-60% by weight of an epoxy resin (comprising bisphenol A epoxide, novolac epoxide, or a mixture thereof);
(2) 5-25% by weight of a hardener or curing agent which comprises:
   (a) a first component comprising a cycloaliphatic amine or an aromatic amine, and
   (b) a second component comprising a polyamide amine, and
(3) a third component comprising 20-65% by weight inert inorganic filler.

The inorganic filler may be composed of one or more of the following: barium sulfate, lithopone, mica, or titanium dioxide. The solidifying/curing composition can be mixed using any suitable method before applying it to the substrate. To extend the shelf life of the curing composition, it is preferable to supply it in two parts, generally consisting of an epoxy as one part and curing agents as the other part. These parts are typically mixed in situ just before application to the substrate.

Either or both of these parts may contain inert fillers and other additives. The substrates to be protected by the composition of the respective invention can be extended substrates, particularly cylindrical ones, such as pipelines or pipes.

The above-noted invention can be selected as the closest prior art analog (prototype). The disadvantages of this invention include the fact that the polymer composition varies widely, which reduces the reliability and durability of the coating in extreme conditions.

The above-noted invention/patent offers enhanced technological features, enabling production of an anti-corrosion coating that better preserves the material's physical, mechanical, and thermomechanical properties after exposure to corrosive and aggressive environments under high pressure and elevated temperatures.

### SUMMARY OF THE INVENTION

One of the essential objects of the present invention is to provide a two-component composition for producing an anti-corrosion coating suitable for use in aggressive conditions of oil and gas production, and in particular to provide a coating for oil grade pipes or tubing.

It is also an object of the invention to provide a new anti-corrosion coating which is resistant to corrosive media, for protecting the surface of pipes.

The technical result of the invention is to provide an increase in the corrosion resistance of the obtained coating.

To solve the problem and achieve the above technical results, there is disclosed a base for a two-component mixture for obtaining a coating, comprising the components in the following ratio:
bisphenol A/P-(epichlorohydrin) epoxy resin-5-25 mass parts;
xylene—10-13 mass parts;
isobutanol—1-5 mass parts;
ethylbenzene—1-3 mass parts;
filler selected from the group consisting of titanium dioxide, calcined kaolin, inert quartz filler and their mixtures—35-70 mass parts;
rheological additive—0,1-1,0 mass parts;
dispersant—0.1-1.5 parts by mass;
deaerator—0.1-2.0 parts by mass.

In the preferred embodiment of the present invention discloses:
the bisphenol A/E-(epichlorohydrin) epoxy resin having a molecular weight of no more than 700 g/mol;
the filler is a mixture of titanium dioxide, calcined kaolin and finely dispersed quartz in the mass ratio of titanium dioxide:calcined kaolin:finely dispersed quartz=10-15:10-25:15-30;
the rheological additive is a solution of polyamide modified with urea;
the dispersant is a polyolefin;
the deaerator is a polyacrylate-based additive.

Another object of the present invention is to provide a hardener/curing agent for use with the above-mentioned base to obtain a two-component mixture used in turn to obtain a coating, wherein the hardener comprises components in the following ratio:
xylene—20-25 mass parts;
N-1,1-diethyl-1,3-diaminopropane—10-20 mass parts;
benzyl alcohol—7-25 mass parts;
isobutanol—5-10 mass parts;
ethylbenzene—3-7 mass parts;
bis(aminomethyl)benzene—3-5 mass parts;
3-(2-aminoethylamino) propyltrimethoxysilane—2-5 mass parts; and
2-hydroxybenzoic acid—1-3 mass parts.

A further object of the present invention is to provide a coating kit comprising the base and the hardener/curing agent, wherein the base and hardener/curing agent are stored separately in sealed containers.

Still another object of the present invention is to provide a method for producing an anti-corrosion coating for protecting a pipe surface using the base and the hardener/curing agent. The method comprises the following steps:
(a) mixing the base (composition A) and the hardener/curing agent (composition B) in a mass ratio of base and the hardener/curing agent from 2:1 to 12:1 to obtain a mixture;
(b) preparing a surface of the pipe;
(c) application of the mixture to the surface of the pipe;
(d) heat treating the pipe with the mixture to produce a corrosion-resistant coating.

In a preferred embodiment of the present invention:
the pipe is an oil grade pipe or tubing;
mixing of the base and the hardener/curing agent is carried out manually or by means of a special automatic dispenser;
mixing of the base and the hardener/curing agent is carried out within 15 minutes until a homogeneous composition is obtained;
base and hardener/curing agent are mixed at a mass ratio of base:hardener/curing agent=5:1;
pipe surface preparation consists of the following steps:
   (i) pipe de-preservation, (ii) thermal degreasing of the pipe, and (iii) mechanical cleaning of the pipe surface;
wherein, the mechanical cleaning of the pipe surface is mechanical blasting of the pipe surface;
application of the mixture is carried out along the entire length of the pipe on the surface and on the pipe ends;
application of the mixture on the pipe surface is carried out by consecutive application of two or more layers of two-component mixture;
the temperature of the two-component mixture when applied to the pipe is from 15 to 35° C.;
the temperature of the pipe when the two-component mixture is applied to it is from 15 to 35° C.;
heat treatment of the pipe is carried out by heating the pipe with the applied two-component mixture in an oven at a temperature from PO up to 170° C. for 60-120 minutes;
thickness of anticorrosion coating is from 120 to 350 microns;
thickness of one coating layer is not less than 60 microns;
the pipe surface represents the inner surface of the pipe.

Still a further object of the present invention is an anti-corrosion coating for protecting the surface of a pipe, wherein such coating is obtained according to any of the above-mentioned methods. In a preferred embodiment of the present invention the surface of the pipe is considered to be an inner surface of the pipe.

The anti-corrosion coating of the present invention offers several advantages over those known from the prior art.

The primary advantage of the protective anti-corrosion coating of the present invention, compared to similar powder coatings, is in the significantly lower cost. This reduction is achieved by utilizing more affordable components and/or their combinations. Additionally, the average thickness of this protective coating is five times less than that of conventional powder coatings of the prior art.

The minimal thickness of the anti-corrosion coating in the present invention is 120 μm, with a standard thickness of 180 μm (when applied in two coats). In contrast, the average thickness of heat-resistant epoxy powder coatings of the prior art with similar purposes and compositions begins at 300 μm.

### DETAILED DESCRIPTION OF THE INVENTION

The anti-corrosion coating consists of a polymerized liquid two-component mixture on an epoxy-phenolic basis of the novolac type. The primer in this protective coating is the first layer of the coating, applied directly to the prepared surface of the pipe.

### Preparation of the Base, Hardener/Curing Agent, Two-Component Mixture and Coating

### 1. Preparation of the Base (Composition A)

The base is prepared by stepwise mixing of the components in the dissolver container at a dispersing cutter speed of 500-1500 rpm. The base composition contains epoxy-novolac resin, as well as additional additives selected from the group consisting of reactive organic solvents, fillers, additives, etc.

Mixing 10-13 mass parts of xylene and 1-5 mass parts of isobutyl alcohol (2-methylpropane-1-ol).

5-25 mass parts of bisphenol A/P-(epichlorohydrin) epoxy resin, i.e. epoxy-diane resin based on a mixture of bisphenol A (diphenylolpropane) with bisphenol F (diphenylolmethane) are dissolved in the previously prepared solvent-mixture of xylene and isobutyl alcohol (2-methylpropane-1-ol).

Then, 0.5-1.5 mass parts of ethylbenzene, 0.05-0.7 mass parts of dispersant are added to the resulting solution; then 35-70 mass parts of filler including: titanium dioxide, calcined kaolin, inert silica filler or a mixture thereof are added.

Then, additional 0.5-1.5 mass parts of ethylbenzene and 0.1-1.0 mass part of rheological additive of inorganic or organic chemical nature, as well as 0.05-0.8 mass parts of dispersant and 0.1-2.0 mass parts of deaerator are added to the resulting mixture.

Mixing is continued until a composition of homogeneous consistency is obtained.

The obtained composition A is poured into a hermetically sealed container and stored until further use to obtain a two-component mixture.

Preferably, a low molecular weight resin having a MW (molecular weight) of 700 or less, such as D.E.R-352 resin, (manufactured by Dow Chemical), is used as the bisphenol A/P-(epichlorohydrin) epoxy resin.

Preferably calcined kaolin of KO-0398 grade is used.

Preferably polyolefin is used as a dispersant.

Preferably, as an inert quartz filler, fine quartz flour of A grade is used as an inert quartz filler.

### 2. Preparation of Hardener/Curing Agent (Composition B)

The hardener/curing agent is prepared by mixing 20-25 mass parts of xylene, 10-20 mass parts of N-1,1-diethyl-1,3-diaminopropane, 7-25 mass parts of benzyl alcohol, 5-10 mass parts of isobutyl alcohol, 3-7 mass parts of ethylbenzene, 3-5 mass parts of bis-(aminomethyl) benzene, 2-5 mass parts of 3-(2-aminoethylamino) propyltrimethoxysilane, 1-3 mass parts of 2-hydroxybenzoic acid in a chemical reactor vessel until the composition of homogeneous consistency is obtained.

Preferably, mixing is carried out using a low-speed mixer at a rotation speed of 60-240 rpm. The resulting mass mixture is then poured into a hermetically sealed container and stored until needed for the preparation of the two-component mixture.

### 3. Preparation of a Two-Component Mixture

The preparation of the two-component mixture involves mixing of the prepared base (composition A) and the prepared hardener/curing agent (composition B), either manually or using a specialized automatic dispenser. The components are mixed in a volume ratio of composition A to composition B ranging from 2:1 to 12:1, with a preferred ratio of 5:1.

For the preparation of the two-component mixture, it is possible to use the hardener/curing agent as indicated above in Section 2 or to use a hardener/curing agent based on phenalkamines, whether of natural or synthetic origin, or a combination of both.

Mixing is carried out until a homogeneous composition is achieved, preferably within 15 minutes. The prepared mixture of the base and hardener/curing agent should be used within a maximum of two hours after the start of mixing for optimal performance.

### 4. Obtaining a Protective Anti-Corrosion Coating

The process of obtaining a protective anti-corrosion coating involves applying the two-component mixture prepared as described above to the prepared surface of the pipe, and its polymerization.

Before applying the two-component mixture, the pipe surface should be cleaned from residues of grease, oil, process fluids, as well as oxides, scale, etc.

Preparation of the product surface is carried out in three stages:
Stage 1—de-preservation;
Stage 2—thermal degreasing; and
Stage 3—mechanical shot blasting of the inner surface.

On the cleaned surface of the pipe no defects, cracks, cracks, foams, delaminations, rolls, sharp protrusions, burrs, scuffs, rough marks, metal delaminations are allowed. The time interval between the end of blast cleaning of the internal surface and the beginning of coating application shall not exceed 1 hour at air humidity of 60% or more and three hours at air humidity of 60% or less. The two-component mixture should be applied evenly along the entire length of the pipe, including the inner surface and the ends. The thickness of the protective anti-corrosion coating should range from 120 to 350 μm, with an allowable deviation of ±20%. When applying multiple layers of the two-component mixture consecutively, the thickness of each individual layer should not be less than 60 microns. The temperature of the two-component mixture during application should be between 15° C. and 35° C., while the temperature of the pipe should be maintained between 15° C. and 35° C.

The coated pipe is then placed in a polymerization oven, where the final polymerization of the coating occurs at a temperature of 170° C., preferably within 1 to 2 hours.

When applying several layers of a two-component mixture, the layers are alternately cured.

The paint shops (departments) should include designated areas for pipe preparation, coating application, drying, and post-drying surface treatment, as well as a preparation section with a storage room for daily supplies of the two-component mixture and other materials. The premises of the paint shop must comply with construction norms and regulations for the design of industrial facilities.

The primary advantage of the liquid coating for oil pipes, compared to similar powder coatings, is its significantly lower cost, achieved through the use of more affordable components and/or their combinations. Additionally, the average thickness of the protective anti-corrosion coating in this invention is five times less than that of conventional powder coatings designed for similar applications.

The corrosion resistance of the coating serves as a key criterion for characterizing and classifying the properties of the protective anti-corrosion coating. This resistance is assessed by measuring the adhesion strength of the coating to steel after exposure to corrosive and aggressive media under pressure and elevated temperature.

The results of adhesion strength tests for the anti-corrosive coating developed in this invention, measured using the normal detachment method (ISO 4624:2002), demonstrate the coating's performance after exposure to corrosive-aggressive media (carbon dioxide, hydrogen sulfide, sodium chloride) in an autoclave under pressure at 130° C., see P58346-2019. These tests reveal no defects in the coating, and corrosion at the site of detachment after exposure to the corrosive-aggressive media was absent.

The following are examples of the embodiments of the present invention. Although these are not the only possible variations, the examples effectively illustrate how the desired technical results can be achieved through different implementations of the invention.

### EXAMPLES OF THE EMBODIMENTS OF THE INVENTION

### Example 1. Preparation of the Base (Composition A)

150 g of bisphenol A/P-(epichlorohydrin) epoxy resin (DER-352 resin) are dissolved in a dissolver container in a previously prepared solvent—a mixture of 120 g of xylene and 30 g of isobutyl alcohol (2-methylpropan-1-ol) at a dispersing cutter speed of 500 rpm. Then 10 g of ethylbenzene, 3 g of dispersant are added, then fillers are added: 130 g of titanium dioxide, 170 g of calcined kaolin (KO-0398) and 200 g of finely dispersed quartz flour grade A. Then additionally 10 g of ethylbenzene and 5 g of a rheological additive of inorganic or organic chemical nature, as well as 4 g of dispersant and 10 g of deaerator are added. Mixing is continued until the composition of uniform consistency is achieved. The resulting mass mixture is then poured into a hermetically sealed container and stored until needed for the preparation of the two-component mixture. In Specific Example 1, one mass fraction is equal to 10 g.

Examples 2-9 were carried out similarly to Example 1, and the component and condition data are summarized in Table 1.

### Example 10. Preparation of Hardener/Curing Agent (Composition B)

23 g xylene, 15 g N-1 L-diethyl P-diaminopropane, 13 g benzyl alcohol, 7 g of 2-methylpropan-1-ol, 5 g of ethylbenzene, 4 g of 1,3-bis(aminomethyl)benzene, 3 g of 3-(2-aminoethylamino)propyltrimethoxysilane, 2 g of 2-hydroxybenzoic acid were mixed in a chemical reactor vessel at a speed of 60 rpm with a slow-speed stirrer until the composition of uniform consistency is obtained. The obtained mass was poured into a hermetically sealed container and stored until further use for the preparation of two-component mixture.

Examples 11-18 were carried out similarly to Example 10, and the component and condition data are summarized in Table 2.

### Example 19. Preparation of a Two-Component Mixture

100 ml of composition A prepared according to Example 1 was mixed with 50 ml of composition B prepared according to Example 10 and mixed by hand for 15 minutes until homogeneous is achieved.

### Example 20. Preparation of a Two-Component Mixture

A total of 1200 ml of composition A, prepared as described in Example 2, was combined with 100 ml of composition B, formulated according to Example 12. The two components were mixed by hand for 15 minutes until achieving a homogeneous mixture.

### Example 21. Preparation of a Two-Component Mixture

A total of 500 ml of composition A, prepared as outlined in Example 3, was combined with 100 ml of composition B, formulated according to Example 13. The two components were mixed by hand for 15 minutes until a uniform mixture was achieved.

### Example 22. Preparation of a Two-Component Mixture

Using an automatic dispenser, 1000 ml of composition A, prepared as described in Example 5, was combined with 100 ml of composition B, formulated according to Example 15. The components were mixed until a uniform mixture was achieved.

### Example 23. Preparation of a Two-Component Mixture

To prepare the two-component mixture, combine 120 ml of Composition A (as detailed in Example 6) with 50 ml of Composition B (as outlined in Example 16). Mix the components thoroughly by hand for 15 minutes, ensuring that a uniformed mixture is achieved.

### Example 24. Preparation of a Two-Component Mixture

1100 ml of Composition A (prepared as described in Example 7) was combined with 100 ml of Composition B (as detailed in Example 17). These two components were mixed by hand for 15 minutes, until a uniform and homogeneous mixture was achieved.

### Example 25. Preparation of a Two-Component Mixture

700 mL of Composition A (as described in Example 8) was mixed with 100 mL of Composition B (as detailed in Example 18) and mixed by hand for 15 minutes, to ensure that a uniform and homogeneous mixture is achieved.

### Example 26. Preparation of a Two-Component Mixture

Using an automatic dispenser, combine 1000 mL of Composition A (prepared according to Example 9) was mixed with 100 mL of Composition B (as outlined in Example I) and mixed for 15 minutes until a homogeneous mixture is achieved.

### Example 27. Obtaining a Protective Anticorrosion Coating

Prior to applying the two-component mixture, the pipe surface was thoroughly cleaned to remove any residues of grease, oil, process fluids, oxides, scale, and similar contaminants. The surface preparation was conducted in three stages:
Stage 1—de-preservation;
Stage 2—thermal degreasing;
Stage 3—mechanical blast cleaning of the inner surface.

After preparation, the cleaned surface of the pipe was free of defects such as cracks, films, delaminations, rolls, sharp protrusions, burrs, scoring, and any signs of metal delamination.

The time interval between the completion of the blast cleaning process on the inner surface of the pipe and the application of the coating was 30 minutes.

The two-component mixture was applied uniformly along the entire length of the inner surface and at the ends of the pipe, achieving a protective anticorrosion coating thickness of 250 microns.

The temperature of the two-component mixture during application was 25° C., while the pipe temperature was 15° C.

The tube with the applied two-component mixture was then placed in a polymerization oven, where final polymerization occurred at 170° C. for 60 minutes.

Examples 28-35 were carried out similarly to Example 27, and the data for the conditions of embodiments is summarized in Table 3.

### Example 36: Investigation of Adhesion Strength of Anticorrosion Coatings

This example evaluates the adhesion strength of the anticorrosion coatings produced in accordance with Examples 27-35.

As a criterion for assessing the protective properties of the anticorrosion coating developed in the invention, corrosion resistance was evaluated by measuring the adhesive strength of the coating to steel before and after exposure to corrosive, aggressive pressurized media at elevated temperatures.

To measure the adhesion strength of the protective anticorrosion coating to steel, the normal detachment method was employed (ISO 4624:2002).

For the adhesion strength study, the coatings were prepared as outlined in Examples 27-35, with the exception that the mixtures were applied to plates of sheet steel measuring 70×150 mm and 0.5-1.0 mm thick, rather than to pipes.

Cylindrical blanks are glued directly to the paint surface using an adhesive.

After the adhesive has cured (dried or set), the bonded samples are tested for tear-off (tensile) strength by measuring the force required to detach the coating from the surface to which it was applied.

The test result is the breakaway force required to overcome adhesion or cohesion in the test coating. A mixed adhesion/cohesion failure may also occur.

The tear-off force is applied in a direction perpendicular to the plane of the coated surface and is increased at a uniform rate not exceeding 1 MPa/s, ensuring that failure of the test specimen occurs within 90 seconds.

Table 4 presents the results of measuring the adhesion strength of the protective anticorrosive coating to steel GOST P58346-2019, using the normal detachment method GOST 32299-2013. This measurement was conducted following exposure to corrosive, aggressive media under pressure at elevated temperatures. The specific test conditions applied are as follows:
Temperature 130° C., 5% NaCl solution, carbon dioxide pressure 10 atm, exposure time 24 hours;
Temperature 130° C., 5% NaCl solution, carbon dioxide pressure 50 atm, exposure time 24 hours.

The results of the adhesion strength study for protective anticorrosion coatings, presented in Table 4, indicate that both carbon dioxide and hydrogen sulfide environments exhibit a deviation of adhesion strength within the permissible 30% range from the initial values (which range from 15.0 to 18.0 MPa). No defects or corrosion were observed at the coating's tear-off point.

### Example 37

For comparison, we present the results of a similar study on the adhesion strength of an anticorrosive coating based on the paintwork material branded “TNZ” (produced by JSC “Neozinc Technology”). This coating serves a similar purpose: protecting oilfield pipes and oil and gas pipelines from corrosive-active media.

The initial adhesion strength of the specified coating based on “TNZ” paintwork is 17.5 MPa, as measured using the normal detachment method GOST 32299-2013.

The adhesion strength of the protective anticorrosive coating based on “TNZ” paintwork to steel, determined by the normal detachment method GOST 32299-2013, is 10.0 MPa after autoclave tests conducted GOST 58346-2019. These tests were performed in a hydrogen sulfide environment under a pressure of 10 atm at a temperature of 130° C. is 10.00 MPa.

The adhesion strength of the protective anticorrosive coating based on “TNZ” paintwork to steel, as determined by the normal detachment method GOST 32299-2013, is 10.8 MPa following autoclave tests conducted GOST 58346-2019. These tests were performed in a carbon dioxide environment under a pressure of 50 atm at a temperature of 130° C.

The adhesion strength of the protective anticorrosive coating based on “TNZ” paintwork to steel, determined by the normal detachment GOST 32299-2013, is 12.2 MPa after autoclave tests conducted GOST 58346-2019. These tests were performed in a hydrogen sulfide environment under a pressure of 10 atm at a temperature of 110° C.

The adhesion strength of the protective anticorrosive coating based on “TNZ” paintwork to steel, measured using the normal detachment method, is 13.0 MPa following autoclave tests conducted GOST 58346-2019. These tests were performed in a carbon dioxide environment under a pressure of 50 atm at a temperature of 110° C.

### Example 38. Comparison of Maximum Heat Treatment Temperatures for Corrosion Protection Coatings

The maximum heat treatment temperature for the protective anticorrosion coating, as described in Example 31, is 260° C. For comparison, the maximum temperature for thermal treatment of a similar liquid protective coating, TC3000C from Hilong Russia, is 204° C.

It has been demonstrated by the present experimental data that the coatings made according to the present invention have improved durability and resistance against corrosive-aggressive pressurized media at elevated temperatures. The experimental data presented above demonstrate that the coatings developed in this study exhibit enhanced durability and resistance to corrosive-aggressive pressurized media at elevated temperatures.

1. A base for two-component mixture for manufacturing an anticorrosion coating, comprising components in the following ratio of mass parts:
bisphenol A/E-(epichlorohydrin) epoxy resin 5-25; xylene 10-13; isobutanol 1-5; ethylbenzene 1-3; filler selected from the group consisting of titanium dioxide, calcined kaolin, inert quartz filler and mixtures thereof 35-70; rheological additive 0.1-1.0; dispersant 0.1-1.5 and deaerator 0.1-2.0.

2. The base of claim 1, wherein the bisphenol A/E-(epichlorohydrin) epoxy resin has a molecular weight of no more than 700 g/mol.

3. The base of claim 1, wherein the filler is a mixture of titanium dioxide, calcined kaolin and finely dispersed quartz in the mass ratio titanium dioxide:calcined kaolin:finely dispersed quartz is 10-15:10-25:15-30.

4. The base of claim 1, wherein the rheology additive is a solution of urea modified by polyamide.

5. The base of claim 1, wherein the dispersant is a polyolefin.

6. The base of claim 1, wherein the deaerator is a polyacrylate based additive.

7. A hardener/curing agent for a two-component mixture to provide an anti-corrosion coating, comprising components in the following ratio of mass parts:
xylene 20-25;
N-1,1-diethyl-1,3-diaminopropane 10-20; benzyl alcohol 7-25;
isobutanol 5-10; ethylbenzene 3-7; bis(aminomethyl)benzene 3-5;
3-(2-aminoethylamino) propyltrimethoxysilane 2-5; and
2-hydroxybenzoic acid 1-3.

8. A kit for making an anti-corrosion coating comprising the base according to claim 1 and the hardener/curing agent comprising components in the following ratio of mass parts:
xylene 20-25;
N-1,1-diethyl-1.3-diaminopropane 10-20; benzyl alcohol 7-25;
isobutanol 5-10; ethylbenzene 3-7; bis(aminomethyl)benzene 3-5;
3-(2-aminoethylamino) propyltrimethoxysilane 2-5; and
2-hydroxybenzoic acid 1-3:
wherein the base and the hardener are stored separately in sealed vessels.

9. A method of making an anti-corrosion coating for protecting a surface of pipe using the base according to claim 1 and the curing agent/hardener comprising components in the following ratio of mass parts:
xylene 20-25;
N-1,1-diethyl-1,3-diaminopropane 10-20; benzyl alcohol 7-25;
isobutanol 5-10; ethylbenzene 3-7; bis(aminomethyl)benzene 3-5;
3-(2-aminoethylamino) propyltrimethoxysilane 2-5; and
2-hydroxybenzoic acid 1-3;
wherein said method comprising the steps of:
(a) mixing the base and the/curing agent/hardener in a mass ratio from 2:1 to 12:1 to form a two-component mixture;
(b) preparing the pipe surface;
(c) applying a/the two-component mixture to the pipe surface; and
(d) heat treating the pipe with the mixture applied thereto to produce a corrosion-resistant coating.

10. (canceled)

11. The method of claim 9, wherein the pipe is an oil well pipe or tubing; the pipe surface is an inner surface of the pipe and the mixing of the base and the curing agent/hardener is carried out manually or by a special automatic dispenser.

12. The method of claim 9, wherein the mixing of the base and the curing agent/hardener is carried out for 15 minutes until a homogeneous composition of the two-component mixture is obtained.

13. The method of claim 9, wherein the mixing of the base and the curing agent/hardener is carried out in a mass ratio of 5:1.

14. The method of claim 9, wherein the pipe surface preparation comprises the following steps:
deconservation of the pipe;
thermal degreasing of the pipe; and
mechanical cleaning of the pipe surface.

15. The method of claim 14, wherein the mixture is applied along an entire length of the pipe to a surface and to ends of the pipe and the mechanical cleaning of the pipe surface is carried out by a mechanical blast cleaning.

16. (canceled)

17. The method of claim 9, wherein the application of the mixture on the pipe surface is carried out by sequential application of two or more layers of two-component mixture.

18. The method according to claim 17, wherein when applying the mixture to the pipe surface a first layer of the mixture applied directly to the prepared pipe surface acts as a primer.

19. The method of claim 9, wherein a temperature of the two-component mixture when applied to the pipe is between 15 and 35° C. and a temperature of the pipe when the two-component mixture is applied thereto is between 15 and 35° C.

20. (canceled)

21. The method of claim 9, wherein the heat treatment of the pipe is carried out by heating the pipe with the two-component mixture applied thereto in an oven at a temperature of from 110 to 170° C. for 60-120 minutes.

22. The method of claim 18, wherein the coating thickness is from 120 to 350 microns and the thickness of one coating layer is at least 60 microns.

23. (canceled)

24. (canceled)

25. An anti-corrosion coating for protecting a surface of a pipe is obtained by the method of claim 9.
